(19) United States
(12) Patent Application Publication
(10) Pub. No.: US 2022/0076878 A1
(43) Pub. Date: Mar. 10, 2022

(54) ELECTRICAL COIL WITH LOW ACOUSTIC RADIATION

(71) Applicants: UNIVERSITE DE TECHNOLOGIE DE COMPIEGNE, Compiegne (FR); CENTRE NATIONAL DE LA RECHERCHE SCIENTIFIQUE, Paris (FR); RTE RESEAU DE TRANSPORT D'ELECTRICITE, Paris La Defense Cedex (FR)

(72) Inventors: Nicolas DAUCHEZ, Compiegne (FR); Vincent LANFRANCHI, Compiegne (FR); Paul GNING, Wasquehal (FR)

(21) Appl. No.: 17/423,405

(22) PCT Filed: Jan. 28, 2020
(86) PCT No.: PCT/EP2020/052069

§ 371 Date: Jul. 15, 2021

(30) Foreign Application Priority Data
Jan. 31, 2019 (FR) FR1900965

(51) Int. Cl. H01F 27/28

(52) U.S. Cl. CPC H01F 27/2823

(57) ABSTRACT

An electrical coil includes a wire of electrically conductive material wound in several turns around a main axis situated inside the coil, each turn making a complete revolution around the main axis, the various turns succeeding one another in an offset manner parallel to the main axis, including openings located between pairs of turns that succeed one another in the direction of the main axis.

### TECHNICAL FIELD

The present invention relates to an electrical coil. It also relates to a system comprising such a coil and a method for using such a coil.

### STATE OF THE PRIOR ART

The coils used to regulate the current in the electricity distribution or transmission grid are subjected to electromagnetic forces resulting from the alternating current powering them. These stresses produce vibrations and an acoustic radiation, which can create noise disturbances.

Currently, one solution is encapsulation (with a sealed structure having sound-absorbing material), which requires a subsequent treatment, which causes a problem of cooling and the efficacy of which is limited at low frequencies.

The aim of the present invention is to reduce the noise disturbance of electrical coils, preferably while decreasing the need for cooling and/or without necessarily being limited to low frequencies.

### DISCLOSURE OF THE INVENTION

This objective is achieved with an electrical coil comprising a wire of electrically conductive material wound in several turns around a main axis situated inside the coil, each turn making a complete revolution around the main axis, the various turns succeeding one another in an offset manner parallel to the main axis, characterized in that it comprises openings between pairs of turns that succeed one another in the direction of the main axis.

The coil can comprise, on at least part or on all of the coil, at least one opening between each pair of turns that succeed one another in the direction of the main axis.

The coil can comprise, on at least part or on all of the coil, at least one opening between groups of turns that succeed one another in the direction of the main axis. Every group preferably comprises the same number of turns.

At least one or every opening separating two turns can comprise a hole through a material separating these two turns. As openings, the coil can comprise several perforations or slits through the material separating turns distributed over the whole circumference of these turns around the main axis, these perforations or slits preferably being spaced apart from one another along the turns by at most 2 mm.

At least one or every opening separating two turns can comprise a space running the length of these two turns over the whole circumference of these turns around the main axis.

The smallest dimension of each opening is preferably at least 0.1 mm.

The openings are preferably set up for a degree of openness of the coil:
greater than or equal to 0.5% (or even 1%) and/or
smaller than or equal to 40%, preferably smaller than or equal to 30%, preferably smaller than or equal to 20%, preferably smaller than or equal to 10%.

The openings are preferably distributed uniformly over the coil.

According to yet another aspect of the invention, a system comprising a coil according to the invention and a power source set up to power the coil electrically with an electrical signal producing, continuously or as a one-off, a vibration of the coil at the frequency f is proposed.

The smallest dimension of each opening is preferably at least equal to

$$δ = \sqrt{\frac{2 μ}{{ρ}_{0} ω}}$$

$$where$$

$$μ = 1.84 {10}^{- 5} kg \cdot {m}^{- 1} \cdot {s}^{- 1}$$

is the viscosity of air at 18° C. and

ρ₀=1.213 kg·m⁻³

is the density of air at 18° C. for an atmospheric pressure of p0=101320 Pa and

ω=2πf

is the angular frequency of the vibration.

The vibration frequency of the coil is preferably comprised between 20 Hz and 20 kHz.

The electrical signal preferably has an intensity of at least 100 A.

According to yet another aspect of the invention, a method for using a coil according to the invention is proposed, in which the coil is powered electrically, by a power source, with an electrical signal producing, continuously or as a one-off, a vibration of the coil at the frequency f.

The smallest dimension of each opening is preferably at least equal to

$$δ = \sqrt{\frac{2 μ}{{ρ}_{0} ω}}$$

$$where$$

$$μ = 1.84 {10}^{- 5} kg \cdot {m}^{- 1} \cdot {s}^{- 1}$$

is the viscosity of air at 18° C. and
ρ₀=1.213 kg·m⁻³
   is the density of air at 18° C. for an atmospheric pressure of p0=101320 Pa and

ω=2πf

is the angular frequency of the vibration.

The vibration frequency of the coil is preferably comprised between 20 Hz and 20 kHz.

The electrical signal preferably has an intensity of at least 100 A.

### DESCRIPTION OF THE FIGURES AND EMBODIMENTS

Other advantages and characteristics of the invention will become apparent on reading the detailed description of implementations and embodiments which are in no way limitative, and the following attached drawings:

FIG. 1 is a diagrammatic profile view of a first embodiment 101 of a coil according to the invention

FIG. 2 is a diagrammatic profile view of a second embodiment 102 of a coil according to the invention

FIG. 3 is a diagrammatic profile view of a third embodiment 103 of a coil according to the invention

FIG. 4 is a diagrammatic profile view of a fourth embodiment 104 of a coil according to the invention

FIG. 5 illustrates different sound pressure level curves generated by different variants of coils according to the invention.

As these embodiments are in no way limitative, it is possible in particular to consider variants of the invention comprising only a selection of the characteristics described or illustrated hereinafter, in isolation from the other characteristics described or illustrated (even if this selection is isolated within a sentence comprising these other characteristics), if this selection of characteristics is sufficient to confer a technical advantage or to differentiate the invention with respect to the state of the prior art. This selection comprises at least one, preferably functional, characteristic without structural details, and/or with only a part of the structural details if this part alone is sufficient to confer a technical advantage or to differentiate the invention with respect to the state of the prior art.

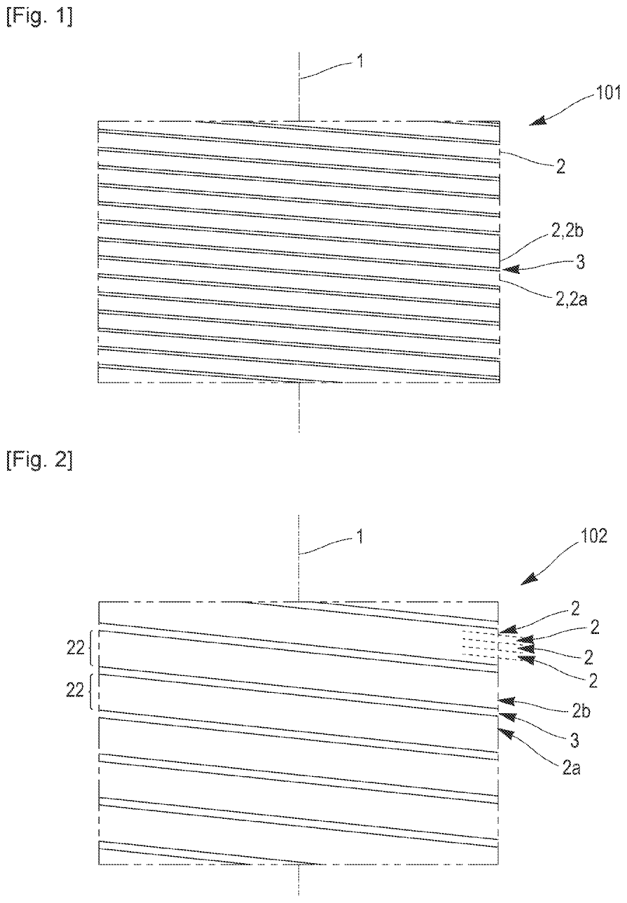

A first embodiment 101 of a coil according to the invention will be described first of all with reference to FIG. 1.

The electrical coil 101 comprises a wire of electrically conductive material wound in several turns 2 around a main axis 1 situated inside the coil 101 and extending in one direction.

The coil 101 is a single-layer or multi-layer industrial coil. In the case of a multi-layer coil, the layers can be contiguous (in this case there is a single cylinder if the coil has a cylindrical shape) or separated (in this case, if the coil has a cylindrical shape, there are several concentric cylinders separated by an air gap).

The coil 101 preferably has a cylindrical shape, but can have different shapes depending on the variant in question, for example a coil 101 with a rectangular cross section.

Each turn 2 makes a complete revolution around the main axis 1.

The various turns 2 succeed one another in an offset manner parallel to the main axis 1. In other words, all of the turns 2 together progressively form a shape which surrounds and runs the length of the axis 1, like a tube for example. These various turns 2 can optionally comprise, locally, several turns 2 contained in one and the same plane perpendicular to the axis 1.

The coil 101 comprises openings 3 between pairs of turns 2a, 2b that succeed one another in the direction of the main axis 1.

The coil 101 comprises, on at least part or on all of the coil 101, at least one opening 3 between each pair of turns 2a, 2b that succeed one another in the direction of the main axis 1.

Each opening 3 is set up to allow free passage of gas (typically of air) through it between the outside of the coil 101 and the inside (i.e. the axis 1) of the coil 101.

This passage of gas (typically of air) from the outside of the coil 101 to the axis 1 makes it possible to reduce the acoustic radiation of the coil 101.

The inside of the coil 101 is defined as being the space comprised between the turns 2 and the axis 1.

The outside of the coil 101 is defined as being the space comprised beyond the turns 2 with respect to the axis 1.

If the coil is borne by a support or a frame, this support or frame is also formed openwork so as not to obstruct the openings 3, such that for each opening 3 a straight line of free path of gas (such as air) can connect the axis 1 to the outside of the coil 101 and to the outside of the support or frame.

Each turn 2 preferably has a height (measured parallel to the axis 1) smaller than 20 cm for the low frequencies of the human hearing range or smaller than 20 mm or smaller than 2 mm for the high frequencies of the human hearing range (20 kHz or less).

Each opening 3 preferably has a height (measured parallel to the axis 1) smaller than the height of a turn 2 (measured parallel to the axis 1).

Each opening 2 preferably has a thickness (measured perpendicular to the axis 1) smaller than or equal to twice the height of each opening 3 (measured parallel to the axis 1).

The coil 101 preferably has a height (measured parallel to the axis 1) greater than ten times the height of a turn (measured parallel to the axis 1).

The coil 101 preferably has an external diameter or more generally (in particular in the case of turns 2 making revolutions in the shape of a square, oval, etc.) at least an external width of the turns 2 (measured in a plane perpendicular to the axis 1) greater than 40 cm.

Each opening 3 follows the slope of the turns 2.

At least one or every opening 3 separating two turns 2a, 2b comprises a space running the length of these two turns 2a, 2b over the whole circumference of these turns 2a, 2b around the main axis 1.

The smallest dimension of each opening 3 is at least 0.1 mm, preferably at least 0.5 mm, preferably at least 1 mm. In this embodiment this smallest dimension is the height of each opening 3 measured parallel to the axis 1.

The height of each opening 3 is smaller than 5 mm.

The openings 3 are set up for a degree of openness of the coil greater than or equal to 0.5% (or even greater than or equal to 1%).

The degree of openness r of the coil 101 is defined as being, in any profile view or image perpendicular to the axis 1 (cf. FIG. 1), the ratio of the surface area of the openings 3 to the total surface area of the coil 101 (this total surface area being the sum of the surface area of the turns 2 and the openings 3). For example, τ=50% when the surface area of the openings 3 represents half of the surface area of the coil 101.

The openings 3 are set up for a degree of openness of the coil 101 smaller than or equal to 30%, preferably smaller than or equal to 10%. This makes it possible to only very slightly modify the inductance of the coil with constant dimensions, or to only weakly modify the dimensions of the coil to preserve its inductance.

The openings 3 are distributed uniformly over the coil 101, i.e. the openings 3 are arranged on the coil 101 with a constant spatial periodicity parallel to the axis 1 and/or along the turns 2.

In the case of the coil 101, the openings 3 are distributed or arranged with a constant spatial periodicity parallel to the axis 1.

In an embodiment example:
the turns 2 are made from aluminium with a rectangular-shaped cross section and the dimensions 25 mm by 20 mm composed of 36 strands with a diameter of 4 mm, and each turn 2 having the shape of a circle, for a total of 18 turns,
the coil 101 forms a cylinder with a height of 394 mm measured parallel to the axis 1 and with an internal diameter of 550 mm measured in a plane perpendicular to the axis 1 and with an external diameter of 600 mm measured in a plane perpendicular to the axis 1, the axis 1 being the axis of revolution of this cylinder,
the openings or slits 3 have a height of 2 mm measured parallel to the axis 1.

A second embodiment 102 of a coil according to the invention will now be described with reference to FIG. 2. The coil 102 will be described only with regard to its differences compared with the coil 101.

The coil 102 comprises, on at least part or on all of the coil 102, at least one opening 3 between groups 22 of turns 2 that succeed one another along the main axis 1.

Every group 22 comprises the same number of turns 2, typically more than or equal to 2 and/or less than or equal to 10.

The openings 3 are always set up for a degree of openness of the coil 102 greater than or equal to 0.5% (or even greater than or equal to 1%).

In an embodiment example:
the turns 2 are made from aluminium with a rectangular-shaped cross section and the dimensions 25 mm by 20 mm composed of 36 strands with a diameter of 4 mm, and each turn 2 having the shape of a circle, for a total of 18 turns,
the coil 102 forms a cylinder with a height of 384 mm measured parallel to the axis 1 and with an internal diameter of 550 mm measured in a plane perpendicular to the axis 1 and with an external diameter of 600 mm measured in a plane perpendicular to the axis 1, the axis 1 being the axis of revolution of this cylinder,
the openings or slits 3 have a height of 3 mm measured parallel to the axis 1,
each group 22 comprises 2 turns.

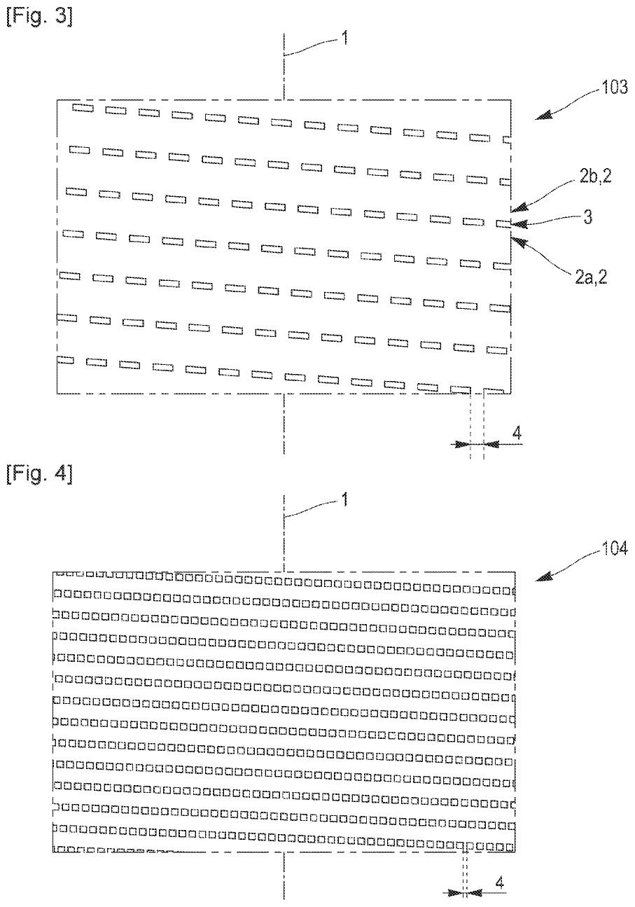

A third embodiment 103 of a coil according to the invention will now be described with reference to FIG. 3. The coil 103 will be described only with regard to its differences compared with the coil 101 or 102.

In this variant of a coil 103 from FIG. 3, for which the openings 3 space out individual turns 2 (as in FIG. 1) or groups 22 of turns (as in FIG. 2), at least one or every opening 3 separating two turns 2a, 2b comprises a hole through a material separating these two turns 2a, 2b.

More precisely, the openings 3 comprise, for each pair of neighbouring turns 2a, 2b in question, several perforations or slits through the material (for example polymer of the ABS (acrylonitrile butadiene styrene) type) separating turns 2a, 2b.

These holes 3 are distributed over the whole circumference of these turns 2a, 2b around the main axis 1.

These holes 3 are preferably spaced apart from one another by a distance 4 (measured along a curved line equidistant from each of the two turns 2 that these holes 3 separate) smaller than the acoustic wavelength determined at the frequency of the vibration f, preferably smaller than or equal to 20 cm (in order to cover the low acoustic frequencies), preferably smaller than or equal to 2 cm (in order to cover the intermediate frequencies), preferably smaller than or equal to 2 mm (in order to cover the high acoustic frequencies).

The smallest dimension of each opening 3 is at least 0.1 mm, preferably at least 0.5 mm, preferably at least 1 mm. In this embodiment this smallest dimension is the height of each hole 3 measured parallel to the axis 1 or the length of each hole (slit or perforation) measured along the two turns 2a, 2b that this opening 3 separates.

The openings 3 are always set up for a degree of openness of the coil 103 greater than or equal to 0.5%, preferably greater than or equal to 1%.

In the case of the coil 103, the openings 3 are distributed or arranged on the coil 103 with a preferably constant spatial periodicity along the turns 2, i.e. along the direction of the slope of the turns 2.

In the case of the coil 103, the openings 3 are distributed or arranged on the coil 103 with a first constant spatial periodicity in the direction of the axis 1 and a second constant spatial periodicity along the turns 2.

The embodiment example of a coil 103 differs from the embodiment example of a coil 101 or 102 in that each opening 3 is a hole in the form of an elongated slit having:
a height of 2 mm measured parallel to the axis 1,
a length of 5 mm measured along the two turns 2a, 2b that this opening 3 separates
a distance 4 to each of its neighbouring openings 3 of 3 mm measured along the two turns 2a, 2b that this opening 3 separates.

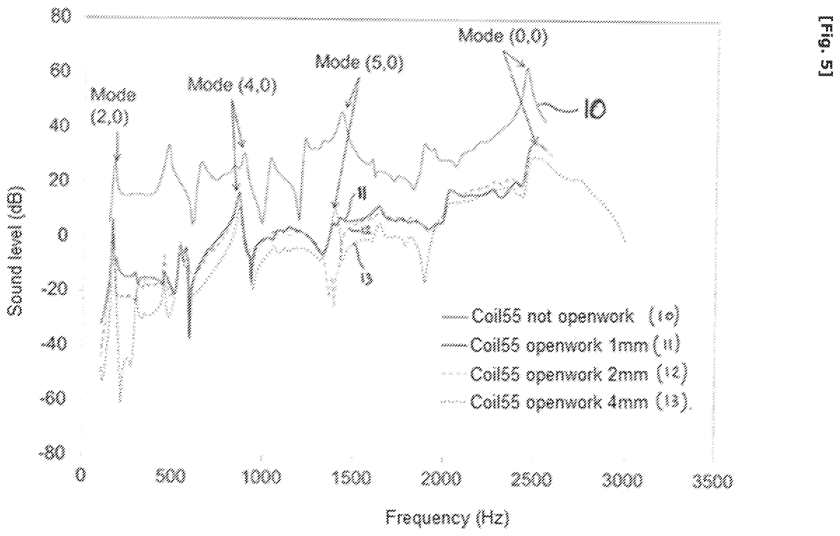

A fourth embodiment 104 of a coil according to the invention will now be described with reference to FIG. 4. The coil 104 will be described only with regard to its differences compared with the coil 103.

The embodiment example of a coil 104 differs from the embodiment example of a coil 103 in that each opening 3 is a hole in the form of a perforation with comparable height and length, i.e. having:
a height of 2 mm measured parallel to the axis 1,
a length of 2 mm measured along the two turns 2a, 2b that this opening 3 separates
a distance 4 to each of its neighbouring openings 3 of 2 mm measured along the two turns 2a, 2b that this opening 3 separates.

The more the size of the openings 3 is reduced (by increasing the number of openings 3), the more locally constant or uniform the degree of openness is.

Thus, the invention consists of making the coil 101, 102, 103 or 104 openwork (with turns 2 partially (FIG. 2) or completely (FIG. 1) non contiguous) so as to reduce the mechano-acoustic conversion of the vibrations to create a sound wave. The presence of spaces (of air or more generally of gas) between the turns 2 produces an acoustic short circuit, which greatly reduces the efficacy of acoustic radiation of the coil 101, 102, 103 or 104.

The invention makes it possible to reduce the acoustic radiation of the coils present in the electricity distribution or transmission grids while substantially preserving the value of the inductance of the coil. This involves applying a vibroacoustic concept to an industrial system.

The invention makes it possible to avoid an effective acoustic radiation of a structure because of its openwork or perforated nature.

An embodiment of a system according to the invention comprising the coil 101, 102, 103 or 104 and a power source will now be described.

The power source is for example a current generator of an electricity distributor, set up to generate a supply electrical signal typically with a fundamental frequency higher than 10 Hz or even 40 Hz and/or lower than 1000 Hz or even 100 Hz (typically equal to 50 Hz or 60 Hz) and a current higher than 100 A or even higher than 1000 A.

The power source is set up to power the coil 101, 102, 103 or 104 electrically with the supply electrical signal producing, continuously or as a one-off, a vibration of the coil at the frequency f typically equal to double the fundamental frequency of the supply electrical signal. Other vibrations of the coil are possible, in particular at higher frequency harmonics or combinations of harmonics.

In other words, the coil 101, 102, 103 or 104 has an acoustic wavelength λ=c/f, where c is the speed of sound of 342 m/s under normal temperature and pressure conditions (18° C. and 101320 Pa) and f is the vibration frequency of the coil 101, 102, 103, 104 borne by its structure.

The smallest dimension of each opening 3 (i.e. height measured parallel to the axis 1 or length measured along the two turns 2a, 2b that this opening 3 separates) is at least equal to the viscous skin depth

$$δ = \sqrt{\frac{2 μ}{{ρ}_{0} ω}}$$

$$where$$

$$μ = 1.84 {10}^{- 5} kg \cdot {m}^{- 1} \cdot {s}^{- 1}$$

is the viscosity of air at 18° C. and

ρ₀=1.213 kg·m⁻³

is the density of air at 18° C. for an atmospheric pressure of p0=101320 Pa and

ω=2πf

is the angular frequency of the vibration.

The smallest dimension (typically the height, measured parallel to the axis 1) of the spacings 3 must be greater than the viscous skin depth, i.e.:
greater than or equal to 15 μm at 20 kHz, i.e. greater than or equal to 0.1 mm, taking a safety margin
greater than or equal to 0.5 mm at 20 Hz, i.e. greater than or equal to 1 mm, taking a safety margin

i.e. in practice at least 0.5 mm (or even 1 mm) for the range of audible frequencies (20 Hz-20 kHz).

In the case of holes or perforations 3, these holes or perforations 3 are preferably spaced apart from one another by a distance 4 (measured along a curved line equidistant from each of the two turns 2 that these holes or perforations 3 separate) smaller than the acoustic wavelength at the frequency of the vibration f, i.e.:
smaller than or equal to 17 m at 20 Hz, i.e. smaller than or equal to 1 m, taking a safety margin
smaller than or equal to 17 mm at 20 kHz, i.e. smaller than or equal to 10 or 2 mm, taking a safety margin

i.e. in practice smaller than or equal to 10 mm (or even 2 mm) for the range of audible frequencies (20 Hz-20 kHz).

The vibration frequency f of the coil is comprised between 20 Hz and 20 kHz.

The supply electrical signal has an intensity of at least 100 A.

An embodiment of a method according to the invention implemented in this system will now be described.

The coil 101, 102, 103 or 104 is powered electrically, by the power source, with the supply electrical signal producing, continuously or as a one-off, the vibration of the coil at the frequency f.

The smallest dimension of each opening 3 is at least equal to

$$δ = \sqrt{\frac{2 μ}{{ρ}_{0} ω}}$$

$$where$$

$$μ = 1.84 {10}^{- 5} kg \cdot {m}^{- 1} \cdot {s}^{- 1}$$

is the viscosity of air at 18° C. and

ρ₀=1.213 kg·m⁻³

is the density of air at 18° C. for an atmospheric pressure of p0=101320 Pa and

ω=2πf

is the angular frequency of the vibration.

The vibration frequency f of the coil is comprised between 20 Hz and 20 kHz.

The supply electrical signal has an intensity of at least 100 A.

FIG. 5 illustrates different sound pressure level curves generated by different variants of coils according to the invention, according to the second embodiment 102 according to the invention, with the following parameters:
the turns 2 are made from copper with a rectangular-shaped cross section and the dimensions 0.5 mm by 1 mm composed of 2 strands with a diameter of 0.5 mm, and each turn 2 having the shape of a circle, for a total of 18 turns,
the coil 102 forms a cylinder with a height of 90 mm measured parallel to the axis 1 and with an internal diameter of 138 mm measured in a plane perpendicular to the axis 1 and with an external diameter of 140 mm measured in a plane perpendicular to the axis 1,
the openings or slits 3 have a height, measured parallel to the axis 1, of:
   h=1 mm for curve 11, for a degree of openness of approximately 2%
   h=2 mm for curve 12, for a degree of openness of approximately 4%
   h=4 mm for curve 13, for a degree of openness of approximately 9%
each group 22 comprises 2 turns, i.e. nine groups 22 with two turns 2.

Curve 10 corresponds to a reference curve outside of the invention, for which h=0, i.e. without opening 3.

The following is found:
an inductance of 0.16 mH for curve 10
an inductance of 0.153 mH for curve 11, i.e. a difference of 4.3% compared with curve 10
an inductance of 0.1505 mH for curve 12, i.e. a difference of 6% compared with curve 10
an inductance of 0.146 mH for curve 13, i.e. a difference of 8.7% compared with curve 10

FIG. 5 compares the sound pressure level generated at 10 m by the non-openwork coil (curve 10) with that generated by the openwork coils 102 (curves 11 to 13). It is noted that there is a very significant decrease in the sound level over all frequencies when the coil 102 is formed openwork. For a coil that is 2% open the level of the mode (2,0) decreases by approximately 20 dB, while the level of the mode (0,0) decreases by almost 29 dB. Between the two, it should be noted that some modes are more attenuated than others. Thus, the level of the mode (4,0) is attenuated by 15 dB while the level of the mode (5,0) decreases by more than 36 dB. It is also interesting to note that the progress of the decrease in the sound is quite weak between a coil that is 2% open and another coil that is 4 or 9% open.

These results show the benefit of the solution of making the coils openwork for reducing the acoustic radiation. The results obtained show overall a very significant decrease in the sound level.

Of course, the invention is not limited to the examples that have just been described, and numerous amendments can be made to these examples without departing from the scope of the invention.

Of course, the different characteristics, forms, variants and embodiments of the invention can be combined with one another in various combinations, unless they are incompatible or mutually exclusive. In particular, all of the variants and embodiments described above can be combined with one another.

1. An electrical coil comprising: a wire of electrically conductive material wound in several turns around a main axis situated inside the electrical coil; each turn making a complete revolution around the main axis, the various turns succeeding one another in an offset manner parallel to the main axis; openings located between pairs of turns that succeed one another in the direction of the main axis; each opening being set up to allow free passage of gas through it between the outside of the electrical coil and the main axis of the electrical coil.

2. The electrical coil according to claim 1, characterized in that the electrical coil comprises, on at least part or on all of the electrical coil, at least one opening between each pair of turns that succeed one another in the direction of the main axis.

3. The electrical coil according to claim 1, characterized in that the electrical coil comprises, on at least part or on all of the electrical coil, at least one opening between groups of turns that succeed one another in the direction of the main axis.

4. The electrical coil according to claim 3, characterized in that every group comprises the same number of turns.

5. The electrical coil according to claim 1, characterized in that at least one or every opening separating two turns comprises a hole through a material separating these two turns.

6. The electrical coil according to claim 5, characterized in that, as holes, it comprises several perforations or slits through the material separating turns distributed over the whole circumference of these turns around the main axis.

7. The electrical coil according to claim 1, characterized in that at least one or every opening separating two turns comprises a space running the length of these two turns over the whole circumference of these turns around the main axis.

8. The electrical coil according to claim 1, characterized in that the smallest dimension of each opening is at least 0.1 mm.

9. The electrical coil according to claim 1, characterized in that the openings are set up for a degree of openness of the electrical coil greater than or equal to 0.5%.

10. The electrical coil according to claim 1, characterized in that the openings are set up for a degree of openness of the electrical coil smaller than or equal to 30%.

11. The electrical coil according to claim 1, characterized in that the openings are distributed uniformly over the electrical coil, i.e. with a constant spatial periodicity parallel to the main axis and/or along the turns.

12. A system comprising: an electrical coil according to claim 1 and a power source set up to power the electrical coil electrically with an electrical signal producing, continuously or as a one-off, a vibration of the electrical coil at the frequency f, the smallest dimension of each opening is at least equal to δ, where
$$δ = \sqrt{\frac{2 μ}{{ρ}_{0} ω}}$$
where the viscosity of air at 18° C. μ is equal to
μ=1.84 10⁻⁵ kg·m⁻¹·s⁻¹
and the density of air at 18° C. ρ₀, for an atmospheric pressure of p0=101320 Pa, is equal to
ρ₀=1.213 kg·m⁻³
and the angular frequency of the vibration ω is equal to
ω=2πf,

13. The system according to claim 12, characterized in that the vibration frequency of the electrical coil is comprised between 20 Hz and 20 kHz.

14. The system according to claim 12, characterized in that the electrical signal has an intensity of at least 100 A.

15. A method for using an electrical coil according to claim 1, in which the electrical coil is powered electrically, by a power source, with an electrical signal producing, continuously or as a one-off, a vibration of the electrical coil at the frequency f; smallest dimension of each opening is at least equal to δ; where
$$δ = \sqrt{\frac{2 μ}{{ρ}_{0} ω}}$$
where the viscosity of air at 18° C. μ is equal to
μ=1.84 10⁻⁵ kg·m⁻¹·s⁻¹
and the density of air at 18° C. ρ₀, for an atmospheric pressure of p0=101320 Pa, is equal to
ρ₀=1.213 kg·m⁻³
and the angular frequency of the vibration ω is equal to
ω=2πf.
